(19) United States
(12) Patent Application Publication
(10) Pub. No.: US 2024/0320122 A1
(43) Pub. Date: Sep. 26, 2024

(54) APPARATUS AND METHOD FOR ANALYZING REPETITIVE ACTIVITY

(71) Applicant: Rootz Research LLC, Newport Beach, CA (US)

(72) Inventors: Robert J. MCCARTHY, Wakefield, MA (US); Eric SPITZ, Orange County, CA (US); Robert J. GRIFFIN, Burlington, MA (US); Paul HUMMEL, Newton Highlands, MA (US)

(21) Appl. No.: 18/612,106

(22) Filed: Mar. 21, 2024

Related U.S. Application Data
(60) Provisional application No. 63/491,685, filed on Mar. 22, 2023.

(51) Int. Cl. G06F 11/34

(52) U.S. Cl. CPC G06F 11/3452; G06F 11/3476

(57) ABSTRACT

An archive of activity data has actions associated with individual unique identifiers. Reporting cycles are defined. Activity data in each reporting cycle is analyzed. Lookback windows covering various segments of activity data are defined. Unpopulated repeater cohort lists and an unpopulated single instance cohort list are populated by grouping unique identifiers associated with similar localized repetitive activity relative to each reference event to form populated repeater cohort lists and a populated single instance cohort list. For each reporting cycle it is validated that each cohort list is mutually exclusive. The populated repeater cohort lists and the populated single instance cohort list are utilized as organizing keys to enable discriminatory parsing and analyzing of ancillary attributes to form output data. The output data is appended to the archive.

### CROSS-REFERENCE TO RELATED APPLICATION

This application claims priority to U.S. Provisional Patent Application No. 63/491,685, filed Mar. 22, 2023, the contents of which are incorporated herein by reference.

### FIELD OF THE INVENTION

This application relates generally to digital analyses of large data sets. More particularly, this application is directed toward digitally analyzing repetitive activity in large data sets.

### BACKGROUND OF THE INVENTION

Advances in cloud computing, personal mobile devices, natural language processing, machine learning, artificial intelligence, and secure broadband wireless connectivity all support increasing scale and control for quantitatively assessing and influencing consumer behavioral responses. Collectively, these technological capabilities increase the connection and value of business operators' product and service offerings with individual consumers.

Existing scientific software applications and methods are known in multi-platform consumer tracking, multi-source database attribute analysis, token-based loyalty programs, targeted advertising engagement, and customer-based valuation. However, much of this work focuses on product sales “supply-side” data and does not directly isolate consumer purchases “demand-side” data. The use of supply-side data presents operational shortcomings, including, but not limited to, the inability to integrate closed-loop feedback control methods with cloud-based analytics and predictive forecasts for the demand-side measurements.

Thus, there is a need for improved analysis of demand-side data in large data sets, particularly with respect to evaluating repetitive activity manifested in such data.

### SUMMARY OF THE INVENTION

An archive of activity data has actions associated with individual unique identifiers. Reporting cycles are defined. Activity data in each reporting cycle is analyzed. Lookback windows covering various segments of activity data are defined. Unpopulated repeater cohort lists and an unpopulated single instance cohort list are populated by grouping unique identifiers associated with similar localized repetitive activity relative to each reference event to form populated repeater cohort lists and a populated single instance cohort list. For each reporting cycle it is validated that each cohort list is mutually exclusive. The populated repeater cohort lists and the populated single instance cohort list are utilized as organizing keys to enable discriminatory parsing and analyzing of ancillary attributes to form output data. The output data is appended to the archive.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

Like reference numerals refer to corresponding parts throughout the several views of the drawings.

### DETAILED DESCRIPTION OF THE INVENTION

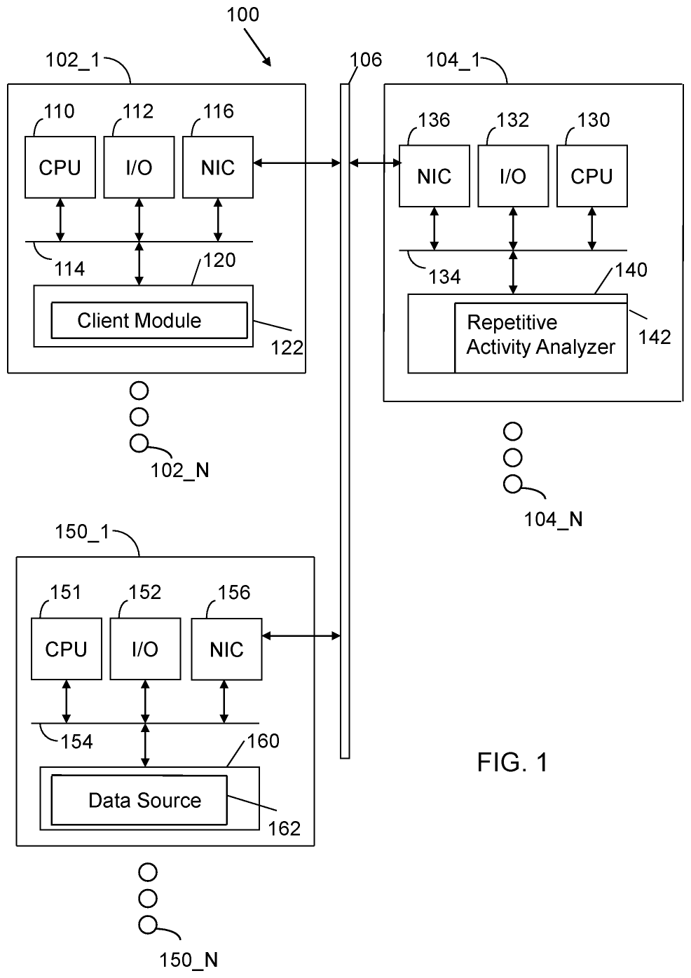

FIG. 1 illustrates a system 100 configured in accordance with an embodiment of the invention. The system 100 includes client machines 102_1 through 102_N connected to server machines 104_1 through 104_N via a network 106, which may be any combination of wired and wireless networks. Data source machines 150_1 through 150_N are also connected to network 106.

The server machines 104_1 through 104_N implement operations disclosed herein. By way of overview, the server machines 104_1 through 104_N collect data from data source machines 150_1 through 150_N. The data is analyzed with a repetitive activity analyzer 142 to derive meaningful insights, as demonstrated below.

Each client machine 102_1 through 102_N includes a processor 110 and input/output devices 112 connected via a bus 114. The input/output devices 112 may include a keyboard, mouse, touch display and the like. A network interface circuit 116 is also connected to the bus 114 to provide connectivity to network 106. A memory 120 is also connected to the bus 114. The memory 120 stores instructions executed by processor 110. In particular, the memory stores a client module 122 that includes instructions to use network 106 to communicate with servers 104_1 through 104_N. Thus, each client machine 102_1 through 102_N can access output from the repetitive activity analyzer 142.

Each server (e.g., server 104_1) includes a processor, 130, input/output devices 132, a bus 134 and a network interface circuit 136 to provide connectivity to network 106. A memory 140 is also connected to the bus 134. The memory stores instructions executed by processor 130 to implement operations disclosed herein. In particular, the memory stores a repetitive activity analyzer 142, the operations of which are detailed below.

Each data server (e.g., 150_1) includes a processor 151, input/output devices 152, a bus 154 and a network interface circuit 156 to provide connectivity to network 106. A memory 160 is also connected to the bus 154. The memory 160 stores a data source module 162 with instructions executed by processor 151 to deliver data to one or more servers 104_1 through 104_N. Example data sources are detailed below.

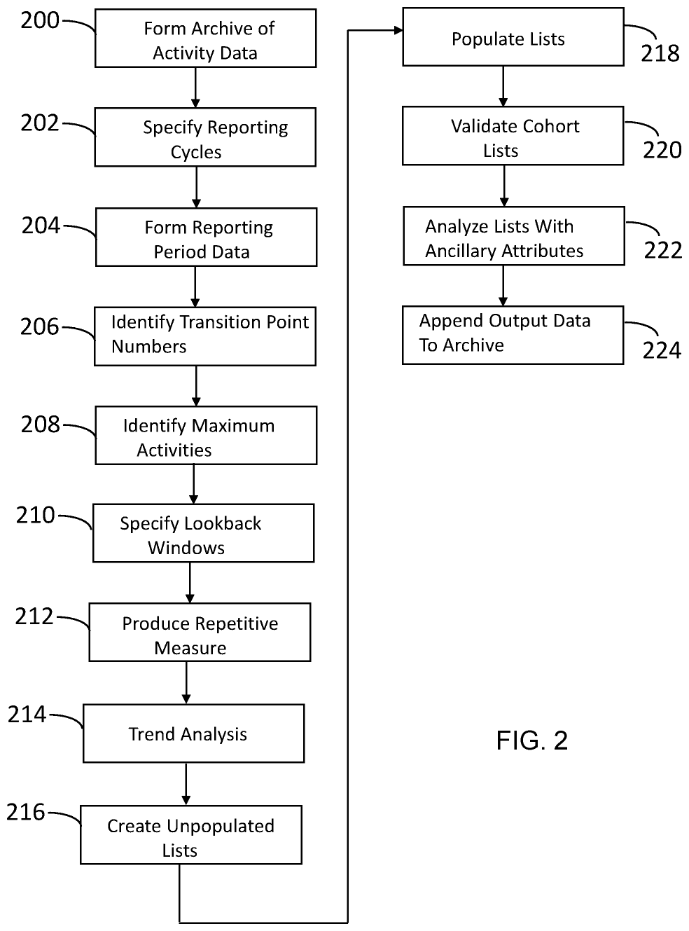

FIG. 2 illustrates processing operations 200 performed by the repetitive activity analyzer 142. An archive of activity data is formed 200. For example, server 104_1 may interact with one or more of data source machines 150_1 through 150_N to form an archive of data in memory 140. The archive of activity data specifies actions associated with individual unique identifiers. Each action has a number. The number may be a sequence number and/or a timestamp. In typical instantiations, the archive is large, being 1 GB or more of data in memory 140.

The next operation of FIG. 2 is to specify reporting cycles 202. Each reporting cycle has a reporting cycle number. The reporting cycle is typically a temporal parameter, such as a day, a month, a quarter, etc.

The next operation of FIG. 2 is to form reporting period data 204. The reporting period data is computed for each reporting cycle. That is, for each reporting cycle, activity data is analyzed to form reporting period data.

Transition point numbers are then identified 206. Transition point numbers designate the start and finish of a reporting cycle. Thus, the transition point numbers are typically temporal parameters, such as a start timestamp and a finish timestamp.

Maximum activities are then identified in reporting cycles 208. That is, activity data in each reporting cycle is analyzed to identify and store the occurrence of the maximum activity number associated with a unique identifier. The unique identifier designates an individual. The activity number is an activity repetitively performed by and/or otherwise associated with the individual.

Next, lookback windows are specified 210. The lookback windows are typically temporal periods of increasing size, such as day, month, quarter, etc. Alternately, the lookback windows may be based upon increasing sequence numbers of activity data.

Next, repetitive measures are produced 212. The repetitive measures are produced from an analysis of each reference event in the activity data for each unique identifier. The reference event is analyzed with respect to prior activity data associated with the unique identifier within each lookback window to produce the repetitive measure of activity data recency and frequency for each reference event.

Trend analysis 214 is then performed. For each reporting cycle, an array of unique identifiers lookback windows is stored. Each array element associates a reference event and its prior corresponding reference event instances to determine a trend. In one embodiment, an array element is set to true if a trend exists or false if a trend does not exist.

Unpopulated lists are then created 216. That is, for each reporting cycle, unpopulated repeater cohort lists are formed, and one additional unpopulated single instance cohort list is formed. Each unpopulated repeater cohort list is a repository for aggregating unique identifiers characterized by localized trends of similar repetitive activity. The unpopulated single instance cohort list has the unique identifiers of individuals that performed an activity one time.

The lists are then populated 218. Array elements are used to group unique identifiers associated with similar localized repetitive activity relative to each reference event. This results in populated repeater cohort lists and a populated single instance cohort list.

The cohort lists are then validated 220. That is, for each reporting cycle, there is validation that each cohort list is mutually exclusive, such that the union of activity data associated with the cohort lists matches the aggregate source activity data for the reporting cycle.

The cohort lists are then analyzed with ancillary attributes 222. That is, the populated repeater cohort lists and the populated single instance cohort list are used as organizing keys to enable discriminatory parsing and analyzing of ancillary attributes, which results in output data. Examples of ancillary attributes are detailed below.

The output data is then appended to the archive 224. The output data may also be conveyed over network 106 to one or more client machines 102_1 through 102_N.

The foregoing operations may be performed in a variety of contexts, including sports and entertainment, venue operations, manufacturing, biomedical, pharmaceutical, travel, recreation, social media, financial, sustainability, renewables, market valuation, e-commerce, and retail operations. The following examples demonstrate the foregoing operations performed in different contexts.

Selected contextual examples are organized in the following four high-level categories to demonstrate a range of potential applications: market valuation, biomedical, retail operations, sports and entertainment.

### Example Category 1 (Simplest Form to Illustrate Main Concepts): Market Valuation Loyalty Indicator

A simplest-form example is an application for loyalty confidence to market valuation. This example compares two peer business entities in the context of a contemplated institutional investment or merger/acquisition. General accounting practices provide financial reporting in various forms: income statement, balance sheet, cash-flow, market capitalization, sales/profit per distribution outlet, etc. These reporting sources quantitatively assess market value and performance of an entity, product, or service. For this example, two peer business entities A and B offer competitive services in a marketplace.

An archive of activity data is formed comprising service subscription records from A and B. For each entity, subscription records contain a unique identifier for each individual customer and associated data fields for subscription revenue and profit by customer. By way of example, a reporting cycle is calendar monthly. For each reporting cycle, the archive is analyzed to identify most recent subscription activity for each unique identifier. In simplest form, one lookback window is specified of a fixed duration, e.g., 135 days. For each subscriber, trend analysis is computed using the lookback window to characterize as repeater or single instance.

Output data is presented as ranked number of repeaters, single instances, and churn, respectively for A and B. Outputs include a loyalty confidence index as computed based on higher repeaters and lower churn. The loyalty index is then used as a robustness indicator to accompany market valuations using traditional established methods from information in the financial reports.

This example intends to provide a simple illustration of the main concepts in the presented method. Additional lookback windows provide more granular levels of customer affinity, which can be extended to time histories characterizing volatility. Additional examples included below describe in further detail the procedural steps, intermediary results, control treatments, output data and activity updates for different embodiments and example application use cases.

### Example Category 2: Bioscience, Biomedical, Healthcare and Pharmaceutical

Another contextual example is an application for patient care using activity-based bioscience analytics. Using the described methods and framework of repeater cohorts, the output data enables an initial assessment followed by passive and/or active monitoring for genetic predispositions and early detection of neurological disorder ailments and progressions.

An archive of activity data is formed with patient records of genetic, physiological, clinical, imaging, biospecimen, biographical, prior injury, exposure, family history and/or other associated data. Each patient record has a unique record number and contains a unique identifier to an individual participant, referenced in this example as PatientID. Each data record associated with a PatientID further contains instances of the described activity data. Typical reporting cycles for healthy PatientIDs are annual. For PatientIDs participating in ongoing monitoring of a condition or ailment, a typical reporting cycle may be monthly, weekly, or more frequent, generally as determined by a medical professional.

For each reporting cycle, activity data is analyzed to form reporting period data, such as physiological metrics of heart rate, respiration, blood pressure, core body temperature, among others. Maximum activities are each PatientID's most recent patient records. Activity number is patient record data repetitively associated with an individual PatientID that may also meet or exceed pre-established thresholds or norms (e.g., healthy human body temperature 98.6 deg F.).

Lookback windows are specified to produce repetitive measures of activity recency and frequency for each PatientID relative to prior activity history for the same PatientID and/or to established healthy norms and standards of a general population. Trend analysis is computed using an array associating each reference activity level with its prior corresponding instances.

Repeater cohort lists are formed and populated with unique identifiers for each PatientID to represent localized trends of similar repetitive patient record activity, including single-instances. Repeater cohort lists are used as organizing keys to enable discriminatory parsing and analyzing of health/wellness measures, slowed progression rates of known ailments or conditions, and other ancillary information. Output data is appended to the archive for subsequent operations and analysis.

By way of a more specific biomarker example, the detection of disease-associated alpha-Synuclein in genetic assays has been investigated with results demonstrating high sensitivity and specificity as a biomarker indicator of severity or progression of Parkinson's Disease or dementia. [refs: MJFF; Neurology Journal November 2022]. Application of the repeater cohort framework and method enables further differentiation and parsing of PatientIDs exhibiting similarities in the underlying genetic factors and associated patient record activity data.

In a further variation of this example, a treatment is introduced in which a temporary medicinal protocol or therapeutic regiment is activated to selected/eligible candidate individual identifier PatientIDs. Output data is monitored before, during, and after the activated treatment duration to measure targeted responses and post-treatment responses as generated in subsequent activity data updates. The feedback-control treatment may be repeated and/or recursively adapted to achieve increasingly desirable outcomes (or to mitigate side effects) as measured by the output data in a closed-loop deterministic manner.

### Example Category 3: Retail Operations, Brand Management, e-Commerce

Another contextual example is an application for retail operations. Using the described methods and resulting repeater cohorts, the output data enables practitioners to optimize pricing, promotions, product assortment, store layout, inventory, other operational functions, and performance metrics.

An archive of activity data is formed comprising transaction records from point-of-sale (POS) information collected at time of purchase. Purchase actions with unique identifiers for individual consumers itemize order information for products and/or services in each numbered order ticket. Typical reporting cycles are daily, weekly, monthly, quarterly, annually, or other durations, along with corresponding transitions.

For each reporting cycle, purchase data is analyzed to form reporting period data. Maximum activities are the most recent purchase activity associated with a uniquely identified consumer with activity in the reporting period data. Activity number is an activity repetitively performed by or associated with the individual consumer.

Lookback windows are specified to produce repetitive measures. The repetitive measures indicate recency and frequency for each purchase transaction for each unique identifier representing a consumer. Trend analysis is computed using an array associating each reference purchase event with its prior corresponding purchase event instances.

Repeater cohort lists are formed and populated with unique identifiers for each consumer to represent localized trends of similar repetitive purchase activity, including single-instance first-time triers. Repeater cohort lists are used as organizing keys to enable discriminatory parsing and analyzing of purchases of products and/or services and other ancillary information such as demographics, weather, time-of-day or day-of-week, or other associated information.

The output data is appended to the archive and presented to practitioners in the form of dashboards or visual/graphical presentations. New purchase activity data updates may be integrated into the archive at any time from various sources. Upon completion of each subsequent or future reporting cycle, activity data including any instantiated updates is processed, and outputs are computed for presentation to practitioners and appended to the archive.

In a variation of this example, a treatment is introduced in which a temporary promotion or price incentive is offered to selected individual identifiers. Output data is monitored before, during, and after the activated treatment duration to measure targeted responses and post-treatment decisions and behavior. The feedback-control treatment may be repeated and/or recursively adapted to achieve desired outcomes as measured by the output data in a closed-loop deterministic manner.

In another variation of this example, derivative attributes are computed using output data to parse the archive. The derivative attributes are then employed to form components of a prompt compatible with generative artificial intelligence (GenAI), and in particular, GenAI employing a large language model (LLM) to customize next best actions for individual consumers.

These methods enable the capability to optimize allocation of promotional and advertising costs/resources to targeted cohorts, with retail operators increasing operational efficiencies through greater effectiveness of marketing programs, advertising campaigns, and other forms of product promotions to their population of consumers.

### Example Category 4: Sports & Entertainment, Recreation, Social, Other Applications

Another contextual example is an application for sports and entertainment venue operations. Current industry practices by single-venue and multi-venue operators include on-premise and off-premise, ticketing (seasonal, group sales, individual seats; empty seats, seat upgrades), dynamic pricing, food and beverage, parking, security, gaming/wagering, hospitality/luxury suite sales, venue alternate uses, merchandise sales, and various third-party outsourced service contracts related thereto. Using the described methods and repeater cohorts, the output data enables venue operators to optimize efficiencies in various operational functions.

For this example, an archive of activity data is formed from ticket purchases and tokenized transactional data from onsite in-game point-of-sale (POS) systems and collected per transaction. Unique identifiers associated with individual spectators correspond to each attendee of games or other entertainment offered by the venue. Reporting cycles are per game, seasonal, annual, or other durations.

For each reporting cycle, transactional data is analyzed to form reporting period data. Maximum activities are the most recent transactions associated with a uniquely identified spectator. Activity number is an activity repetitively performed by or associated with the individual consumer, including prior history at the venue during other venue operated events.

Lookback windows are specified to produce repetitive measures, including in-game, and optionally, in pre-game and post-game, if sufficient activity data history exists in the archive for an individual spectator identifier. The repetitive measures indicate recency and frequency for each transaction for each spectator. Trend analysis is computed using an array associating each transaction with its prior corresponding instances.

Repeater cohort lists are formed and populated with spectator identifiers to represent localized trends of similar repetitive activity, including single-instances. Repeater cohort lists are used as organizing keys to enable discriminatory parsing and analyzing of prior spectator transactions and other ancillary attributes such as demographics, current weather and/or weather forecast, day-of-week or other in-game situational occurrences (e.g., halftime or intermission, 7th inning stretch, rivalry game tied score, bases loaded full-count 2-outs, playoff contention, overtime, pending world record, etc).

The output data is appended to the archive and presented to venue operator staff in the form of dashboards or visual/graphical presentations. New activity data updates are integrated from various sources. Upon completion of each subsequent or future reporting cycle, activity data including any instantiated updates is processed, and outputs are computed for presentation and next actions.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media, optical media, magneto-optical media, and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using an object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A non-transitory computer readable storage medium with instructions executed by a processor to:
form an archive of activity data comprising actions associated with individual unique identifiers, each action having a number, the archive consuming at least 1 GB within the non-transitory computer readable storage medium;
specify reporting cycles, each reporting cycle having a reporting cycle number;
compute for each reporting cycle activity data to form reporting period data;
identify and store transition point numbers for all reporting cycles;
analyze activity data in each reporting cycle to identify and store the occurrence of the maximum activity number associated with a unique identifier;
specify lookback windows as number progressions;
analyze for each reference event in the activity data for each unique identifier the same prior activity data associated with the unique identifier within each lookback window to produce a repetitive measure of activity data recency and frequency for each reference event;
store for each reporting cycle an array of unique identifiers lookback windows, in which each array element associates a reference event and its prior corresponding reference event instances to determine a trend to assign the array element true if valid and false if invalid;
assign for each reporting cycle unpopulated repeater cohort lists and one additional unpopulated single instance cohort list, each unpopulated repeater cohort list being a repository for aggregating unique identifiers characterized by localized trends of similar repetitive activity;
populate the unpopulated repeater cohort lists and the unpopulated single instance cohort list by utilizing array elements to group unique identifiers associated with similar localized repetitive activity relative to each reference event to form populated repeater cohort lists and a populated single instance cohort list;
validate for each reporting cycle that each cohort list is mutually exclusive, such that the union of activity data associated with the cohort lists matches the aggregate source activity data for the reporting cycle;
use the populated repeater cohort lists and the populated single instance cohort list as organizing keys to enable discriminatory parsing and analyzing of ancillary attributes to form output data;
append the output data to the archive; and
convey the output data over a network to a user.

2. The non-transitory computer readable storage medium of claim 1 wherein the number is a sequence number.

3. The non-transitory computer readable storage medium of claim 1 wherein the number is a timestamp.

4. The non-transitory computer readable storage medium of claim 1 further comprising instructions executed by the processor to receive new activity data to form an augmented archive.

5. The non-transitory computer readable storage medium of claim 4 further comprising instructions executed by the processor to:
designate a current reporting cycle using initial and final conditions;
analyze within the current reporting cycle by using the augmented archive to generate current reporting cycle activity levels and repeater cohorts, including single instance cohort;
compute new augmented archive output data results for the current reporting cycle;
store the new augmented archive output data results for the current reporting cycle; and
increment the current reporting cycle to a next reporting cycle.

6. The non-transitory computer readable storage medium of claim 4 wherein the augmented archive is analyzed to form a predictive next best action.

7. The non-transitory computer readable storage medium of claim 4 further comprising instructions executed by the processor to augment the new activity data with metadata including a unique record locator, origination timestamp and latest timestamp.

8. The non-transitory computer readable storage medium of claim 7 further comprising instructions executed by the processor to use the metadata to prevent utilization of a duplicate copy or an older timestamped non-duplicate variation of previously recorded activity data.

9. The non-transitory computer readable storage medium of claim 1 further comprising instructions executed by the processor to organize the output data in accordance with ancillary attributes.

10. The non-transitory computer readable storage medium of claim 9 wherein the ancillary attributes are selected from a multi-level categorical hierarchy, branding information, demographic information, temporal information, spatial attributes and weather information.

11. The non-transitory computer readable storage medium of claim 1 further comprising instructions executed by the processor to:
specify a treatment activated upon a pre-specified initial condition and deactivated upon a pre-specified final condition; and
generate treatment activity data comprising treatment actions associated with individual unique identifiers.

12. The non-transitory computer readable storage medium of claim 11 wherein the treatment is a promotional activity in a retail environment.

13. The non-transitory computer readable storage medium of claim 11 wherein the treatment is a medical procedure or therapeutic process.

14. The non-transitory computer readable storage medium of claim 11 wherein the treatment is a content recommendation engine.

15. The non-transitory computer readable storage medium of claim 11 wherein the treatment is a regulatory action.

16. The non-transitory computer readable storage medium of claim 1 further comprising instructions executed by the processor to generate lists of unique identifiers for the reporting cycles, wherein each list has unique identifiers for individuals with similar repetitive activity.

17. The non-transitory computer readable storage medium of claim 16 wherein the similar repetitive activity is a changed repetition rate.

18. The non-transitory computer readable storage medium of claim 16 wherein the similar repetitive activity is a first instance of a repetition rate.
